(19) United States
(12) Patent Application Publication
(10) Pub. No.: US 2012/0218184 A1
(43) Pub. Date: Aug. 30, 2012

(54) ELECTRONIC FINGER RING AND THE FABRICATION THEREOF

(76) Inventor: Stanley Wissmar, Jarfalla (SE)

(21) Appl. No.: 13/505,452

(22) PCT Filed: Oct. 27, 2010
(86) PCT No.: PCT/SE2010/051167

§ 371 Date: May 1, 2012

(30) Foreign Application Priority Data
Nov. 2, 2009 (SE) 0901401-0

(51) Int. Cl. G06F 3/033

(52) U.S. Cl. 345/158

(57) ABSTRACT

The present invention provides an electronic finger ring (1) for wireless, 4-dimensional remote steering and/or monitoring. The electronic finger ring comprises electronic components packaged and integrated in different ways to obtain either omni- or unidirectional RF transmission dependent on its application, e.g. acting as a multiple steering device communicating with nearby electronic devices wirelessly or for wireless user medical diagnostics.

### TECHNICAL FIELD OF THE INVENTION

The present invention relates to a toroidal finger ring, in particular to such an accessory comprising several electrical- and micromechanical components acting as a multiple sensor device communicating with nearby electronic devices wirelessly with e.g. bluetooth technology.

### BACKGROUND OF THE INVENTION

A computer mouse (or equivalent touchpad or touchscreen) is used as a steering device to control the two dimensional (horizontal and vertical) motion of an icon on a computer screen (stationary pc, laptop, pda). It takes up large space which limits the user's freedom of movement. Through the years several types of models has been developed and manufactured; mechanical-, optical-, laser- and inertial-computer mouses. The last mentioned using accelerometers to steer the mouse pointer in x- and y-directions.

Another application uses micromechanical accelerometers on top of a finger ring to control sound effects to an electric guitar (see www.sourceaudio.netlindex.php).

On yet another application a finger ring is used for mobile voice communication where it is integrated with a microphone and speakers in order to transfer sonar vibrations from the speakers (see “A finger-ring shaped wearable handset based on bone-conduction”, Fukumoto, M; Wearable Computers; Proceedings, Ninth IEEE International Symposium on 18-21 Oct. 2005, pages 10-13).

U.S. Pat. No. 2003/0142065 A1 describes a ring-like device which encompasses several electronic components carried on a flexible printed circuit board (FPCB).

U.S. Pat. No. 2003/0227437 A1 describes a pointing device which is characterized by a band that is mountable on a computer user's thumb.

U.S. Pat. No. 2004/0032346 A1 describes a distancing sensing unit to function primarily as a virtual keyboard.

U.S. Pat. No. 2005/0052412 A1 describes a human interface machine interface used exclusively as a computer mouse type device.

U.S. Pat. No. 2006/0001646 A1 describes an operating device which is “C” shaped.

German Pat. No. DE102005021527 A1 describes an operating device which has electronic components embodied in a structure mounted on top of the finger ring.

U.S. Pat. No. US005638092 describes a cursor control system exclusively used in connection to a keyboard.

### SUMMARY OF THE INVENTION

It is an object of the invention to solve or at least mitigate one or more problems associated with the above mentioned devices according to prior art.

In particular, it is an object of the invention to provide a user-friendly steering device for controlling an external electronic device, such as a computer.

This object is achieved by an electronic finger ring as defined by claim 1.

This electronic finger ring offers an effective and ergonomic way of steering/controlling an external electronic device in up to four dimensions.

Specific embodiments of the invention are defined in the dependent claims, the advantages of which are apparent from the detailed description following hereinafter.

The present invention is based on the understanding that an alternative steering device design, compared to an established computer mouse, can be achieved using an electronic finger ring based on a 4-dimensional steering device control integrated in the rings interior.

According to a first aspect of the present invention, there is provided an accelerometer for motion sensing, to steer in a 3-dimensional space. There is further provided a micromechanical pressure sensor in order to steer in an additional 4^{th} dimension, i.e. a steering device design which facilitates to additionally move/control a mouse cursor in a 4^{th} dimension on a computer screen (or equivalent). This gives the user the ability to; for example, zoom in or out of a picture on a computer screen. Additionally custom pre-configure it to the users need in different situations dependent on application; like in a home environment: turn on or off home entertainment system in 1^{st} dimension; change to tv- music- or movie mode in a 2^{nd} dimension; change tv channel/music- or movie track in a 3^{rd} dimension and start-, stop- or pause track in a 4^{th} dimension. That the pressure sensor is adapted to allow steering in an additional 4^{th} dimension means, at least in some embodiments of the invention, that the pressure sensor is adapted to control a function of the external electronic device not relating to steering in a 3-dimensional space.

Alternatively, the micromechanical pressure sensor may function as a finger plethysmograph providing a non-invasive measurement for changes in finger blood flow reflected by pulse wave amplitude (PWA).

The above mentioned active components are combined with mixed signal microcontrollers enabling control and signal processing of these aforementioned active components. To communicate with other, external electronic devices a radio frequency (RF) transceiver is electrically connected to the previous mentioned active components. All the aforementioned electronic components are mounted on a flexible printed circuit board (FPCB) where conductor lines electrically connect the individual components. The actual order and placement of the respective components are novel in order to obtain the desired functionality and packaging inside the toroidal shaped ring. To obtain matching currents and voltages for individual active components passive components are connected. These passive components could either be mounted on the FPCB as individual physical components or be integrated in the FPCB.

To supply power to the components, they may be connected to a battery integrated in the electronic finger ring. In one embodiment, these aforementioned components constitute the internal electronic circuit of the electronic finger ring.

An alternative to provide a source of energy is integrating the conformal coating with piezoelectric nanofibers (for example, pzt—lead zirconate titanate—or zink oxide materials), which converts mechanical energy to electrical energy, which can be placed/located on both the outer- and/or inner circumference of the fpcb and connected electrically to the fpcb to provide electricity to the electrical components.

Yet an alternative power source for powering the electronic components of the finger ring is a coil for generating induced current to the components when the ring is subject to an alternating magnetic field. Such a coil may be integrated in the ring and be used instead of, or in addition to, a battery and/or piezoelectric nanofibres.

In an embodiment of the present invention, after the electrical components are mounted and electrically connected to the FPCB they are covered with nonconductive, conformal coating.

To further reduce the RF radiation on the electrical components as well as the user's finger, the conformal coating, coated on the inner circumference of the FPCB, is mixed with cenospheres, a material which functions as a RF shielding. In one embodiment, the above mentioned piezoelectric nanofibers are integrated in the conformal coating.

A great advantage of the electronic finger ring of the present invention is that the whole ring constitutes the complete electronic circuit. That is, the complete electronic circuit is integrated in the interior of the electronic finger ring. In one embodiment in which the ring is a toroidal shaped metal ring it functions as (i). an external antenna, to obtain coarse tuning to the operational frequency, connected to the internal antenna and RF transceiver located inside the ring or as an (ii) electric ground plane to the internal antenna.

In an embodiment of the present invention, constituting the top metal layer on the interfaces of the toroidal halves is a material which has two functions, (i). to enhance the welding between the joints by its chemical, adhesive properties and (ii). enhancing the hermetic encapsulation (i.e. lowering the pressure in the sealed ring cavity) by its getter properties.

In an embodiment of the present invention, the aforementioned pressure sensor is located in a cavity within the electronic finger ring where the inlet hole geometry is shaped as a horn cone to maximize the pressure compression ratio at the pressure sensor end.

In an embodiment of the present invention, the aforementioned cenospheres can further be deposited on the exterior of the inner circumference of the ring shell in order to reduce RF radiation on the user's finger.

In an embodiment of the present invention to adapt and optimize to different applications the antenna has different designs : (i). External, omnidirectional (ii). internal integrated unidirectional (iii). internal integrated unidirectional with extended, elevated housing (iv). Dielectric integrated with folded monopole.

An intermediate metal strip layer is designed to function as a microstrip feed (transmission) line, electrically connecting an RF transceiver with the internal antenna, preferably optimized to obtain 50 Ω matching impedance. This implies limitations in how the components, the internal antenna and RF transceiver, are placed within the toroidal shaped finger ring.

In an embodiment of the present invention, to complete the design of the aforementioned antennas they are respectively combined with a ground plane located in (i). intermediate layers in the FPCB (ii). or when a portion of the toroidal shaped ring has a dielectric part integrated with folded monopole antenna, the remaining toroidal shaped outer metallic shell functions as a ground plane.

In an embodiment of the present invention, a portion of an outer metal shell is opened to function as a window housing to allow unperturbed RF radiation either (i). having a shape which is identical to the toroidal ring or (ii). Constitute of a dielectric material in said portion of ring or (iii). have a locally extended, elevated sphere shape to minimize return losses of the RF radiation.

Another object of the invention is to provide an alternative use of a finger ring apart from being an aesthetical and/or cultural valued item.

Other objects of the invention are to address the following problems:
how to integrate an antenna having either omnidirectional or unidirectional radiation properties in a finger ring,
how to design an electric circuit comprising various electrical- and/or micromechanical components which can be integrated in a normally sized finger ring,
how to manufacture a finger ring comprising integrated electrical- and/or micromechanical components,
how to manufacture such a ring in a way that increases the lifetime and/or the performance of the ring.

Yet another object of the invention is to provide an electronic finger ring design allowing the ring to be adapted for one or more of the following applications:
(i). Steer and control the functions of electronic devices which are in the users immediate vicinity
(ii). Identification—to use instead of an ordinary security pass card
(iii). Electronic payment—to use instead of an existing credit card
(iv). For continuous measurement and diagnosis of a user's health state—A person diagnosed with Parkinson disease needs his or hers finger or hand tremor movements to be continuously monitored in order to receive proper medication or treatment by medical staff
(v). For mute persons—to improve real-time communication with people who do not understand sign language
(iv). For communication—to inform the ring user about something
(vii). Assault larm—when suspecting assault the person carrying the electronic fingering can perform an immediate action with the ring and a signal is wirelessly transmitted to his or her's mobile phone which in turn automatically sends an emergency call for help
(viii). Finger Plethysmograph—to provide a non-invasive measurement for changes in finger blood flow reflected by pulse wave amplitude (PWA) for accurate data collection technique, used for example monitoring heart periods for use in heart rate variability (HRV) calculations.

All of the above objects may be achieved according to the invention by means of a toroidal shaped finger ring hermetically encapsulating electrical components allowing the ring to communicate wirelessly with electronic devices in its immediate vicinity while at the same time having the aesthetic properties of a conventional jewellery ring.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein the same reference numerals are used for similar elements, and in which:

FIG. 1 is a schematic profile view of the electronic finger ring where the electronic components are mounted on a flexible printed circuit board packaged inside the torus shaped finger ring with a pressure sensor facing the inner boundary of the torus in accordance with an embodiment of the present invention.

FIG. 2 is a schematic top view of the electronic components mounted on both sides of a flexible printed circuit board.

FIG. 3 is a schematic profile view zoomed on the inlet hole shaped as a horn cone to maximize the pressure compression ratio at the pressure sensor end.

FIG. 4 is a schematic profile view of the electronic components mounted on a flexible printed circuit board packaged inside a torus shaped finger ring with an alternative design having the pressure sensor being placed on the outer boundary of the torus.

FIG. 5 is a schematic profile view of the electronic components mounted on a flexible printed circuit board packaged inside a torus shaped finger ring with an alternative design having a folded monopole antenna.

FIG. 6. is a schematic top view of the electronic components mounted on both sides of a flexible printed circuit board having an alternative design with a folded monopole antenna.

FIG. 7 is a schematic three dimensional view of the torus shaped electronic finger ring where the outer and inner metal shells are constituted of two different metals to allow unidirectional, unperturbed RF radiation in accordance with another embodiment of the present invention.

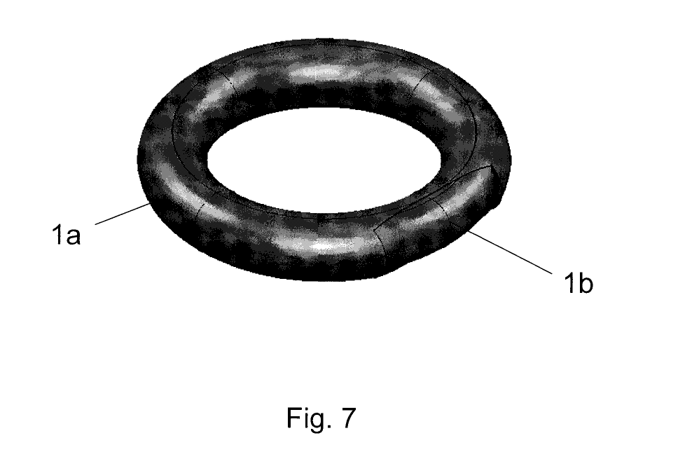

FIG. 8 is a schematic, three dimensional illustration of the cross section of the inner and outer toroidal shells showing how the different metal layers are deposited in accordance with another embodiment of the present invention.

FIG. 9 is a schematic illustration of the top and bottom halves of the ring toroidal shell where the interface (as well as inner surface) is a titanium compound in accordance with another embodiment of the present invention.

FIG. 10 is a schematic view of an external, coarse, omnidirectional design where the whole toroidal shaped metallic shell functions as an RF antenna in accordance with an embodiment of the present invention.

FIG. 11 is a schematic view of where the internal, unidirectional antenna is located where the outer shell is opened leaving the inner shell exposed (constituted of Titanium compound) to allow unperturbed RF radiation in accordance with an embodiment of the present invention.

FIG. 12 is a schematic view of an extended, unidirectional antenna housing constituted of an integrated sphere design which has no top shell material deposited leaving the inner shell exposed (constituted of Titanium compound) to allow unperturbed RF radiation transmission in accordance with an embodiment of the present invention.

FIG. 13 is a schematic illustration of a monopole antenna design integrated in a dielectric material in accordance with an embodiment of the present invention.

FIG. 14 is a schematic illustration of a monopole antenna design which is located where an outer shell is opened leaving the inner shell exposed to allow unperturbed RF radiation in accordance with an embodiment of the present invention.

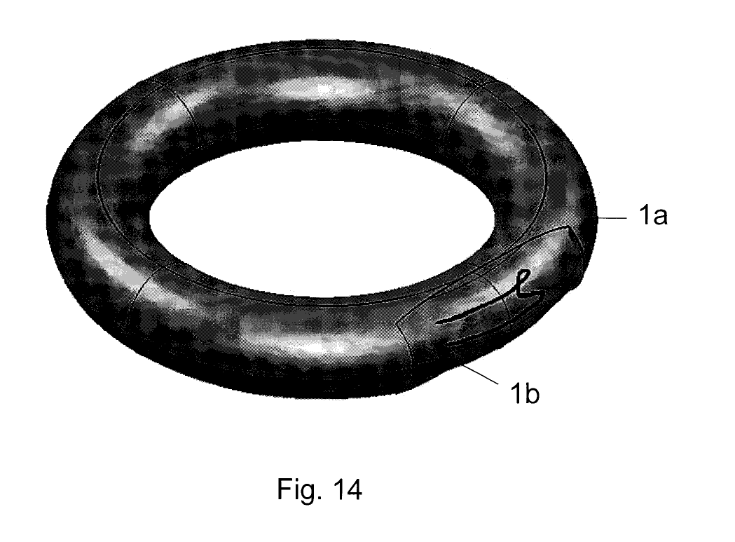

FIG. 15 is a schematic view of how the ground planes on the FPCB are designed. The ground plane facing the outer circumference of the ring acts as a ground plane for the RF antenna circuitry, the ground plane facing the inner circumference of the ring acts as a ground plane and optionally also a thermal heat sink for the electronic components; in accordance with an embodiment of the present invention.

FIG. 16 is a schematic view showing how the microstrip is connected to the RF transceiver with the adjacent groundplanes as intermediate layers in the FPCB. Additional conductor lines, Vcc etc. are not shown; in accordance with an embodiment of the present invention.

FIG. 17 is a cross sectional view of the folded monopole antenna showing how it obtains its desired geometry after integrated in the ring in accordance with an embodiment of the present invention.

FIG. 18 is a top view of the folded monopole antenna in accordance with an embodiment of the present invention.

FIG. 19 is a three-dimensional illustration view of the folded monopole antenna in accordance with an embodiment of the present invention.

### DETAILED DESCRIPTION OF EMBODIMENTS OF THE INVENTION

The following description is of the best mode presently contemplated for carrying out the invention. This description is not to be taken in a limiting sense, but is made merely for the purpose of describing the general principles of the invention. The scope of the invention should be determined with reference to the claims.

A toroidal shaped, electronic finger ring constitutes the complete electronic circuit. The toroidal shaped metal ring functions as either (i). an external antenna, to obtain coarse tuning to the operational frequency, which is connected to the internal antenna and RF transceiver located inside the ring or as an (ii) electric ground plane to an internal antenna.

The electronic finger ring functions as a 4-dimensional steering device where an accelerometer steers in 3-dimensional space and a pressure sensor steers in an additional 4^{th} dimension, i.e. a novel steering device design.

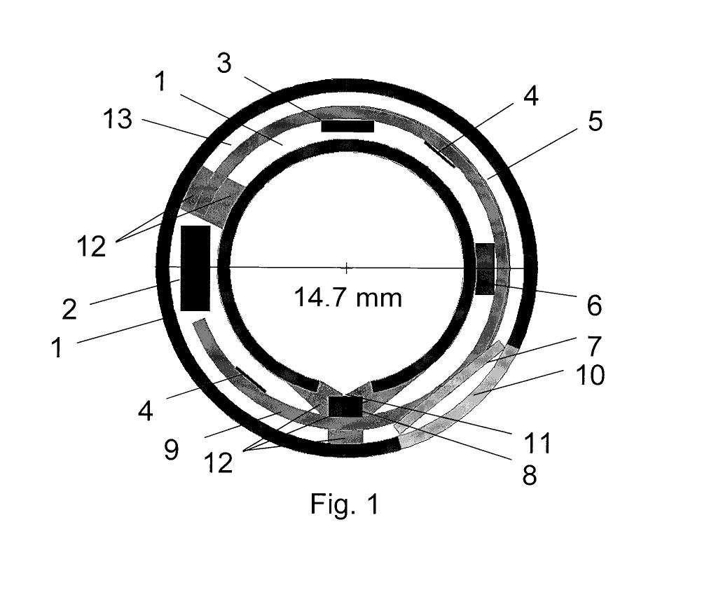

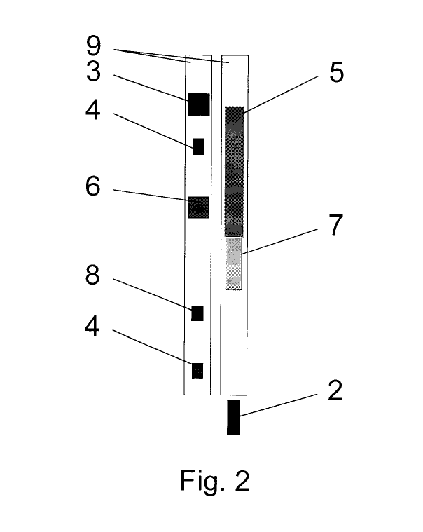

With reference to FIGS. 1 and 2, a first embodiment of the present invention is a toroidal shaped finger ring structure 1, constituted of two different metallic shells: (i). 1a, made of gold (Au) or silver (Ag), enclosing the major parts of the finger ring structure geometrically described as radially furthest away from the toroids centre, and (ii). 1b, made of a titanium compound (Ti, TiW), being the metal enclosing facing the inner parts of the finger ring structure. The toroidal shaped finger ring structure 1 is comprised of different electronic components: a battery 2, a RF transceiver 3 and a micro processor 4, a microstrip line 5, an accelerometer 6, an internal antenna 7, a pressure sensor 8; all mounted on a flexible printed circuit board 9. In this embodiment, there is also an outer metal shell opening 10 serving as an RF window letting through unperturbed RF radiation. In this embodiment, at the inner boundary of the toroidal shaped finger ring structure 1 located at the pressure sensor 8 there is an inlet hole shaped as a horn cone to maximize the pressure compression ratio at the pressure sensor end 11. To permanently place the pressure sensor and one end of the flexible printed circuit board in respective places, fixtures 12, are casted as part of the metallic shell. In this embodiment, there is a protective coating layer 13 located between the outer boundary of the toroidal shaped finger ring structure 1 and the flexible printed circuit board 9, and another form of protective coating (with cenospheres) 14 located between the inner boundary of the toroidal shaped finger ring structure 1 and the flexible printed circuit board 9, as explained above. The internal antenna 7 is connected to the RF transceiver 3 by a microstrip line 5, where the design of the microstrip is optimized to obtain 50 Ω matching impedance. In the case of an external antenna option, the outer shell of the toroidal shaped finger ring structure 1 serves as a coarse antenna. In the case of using exclusively an internal antenna option, the internal antenna is located at a position along the circumference of the toroidal shaped finger ring structure 1 where there is no outer metallic shell covering 10 allowing unperturbed, unidirectional radiation.

In this embodiment, the above mentioned active components are combined with micro processor 4 enabling control and signal processing of these aforementioned active components. To communicate with other, external electronic devices an RF transceiver is electrically connected to the previous mentioned active components. All the aforementioned electronic components are mounted on a flexible printed circuit board (FPCB) where conductor lines electrically connect the individual components. The actual order and placement of the respective components are optimized in order to obtain the desired functionality and packaging inside the toroidal shaped ring. To obtain matching currents and voltages for individual active components passive components are connected (not shown). These passive components could either be mounted on the FPCB as individual physical components or be integrated in the FPCB.

To supply power to the components a battery 2 is connected. These aforementioned components comprise the internal electronic circuit of the electronic finger ring.

In this embodiment of the present invention, after the electrical components are mounted and electrically connected to the FPCB they are painted with a nonconductive and preferably conformal coating 13. Commonly used conformal coatings are silicone, epoxy, acrylic, urethane and paraxylene. The function of the coating is to (i). prevent damage from rough handling, (ii). reduction of mechanical and thermal stress as well as (iii). prolonging the lifetime of the components. Also to (iv). increase the dielectric strength between conductors lines on the FPCB enabling the design of the FPCB to be more compact and small.

As the electrical components are mounted on one side of the FPCB, the inside circumference of the FPCB, the conformal coating absorbs the stress released from forming the FPCB into a toroidal/circular shape, thus reducing the risk of the respective electrical component and FPCB losing mechanical or electrical connection to each other.

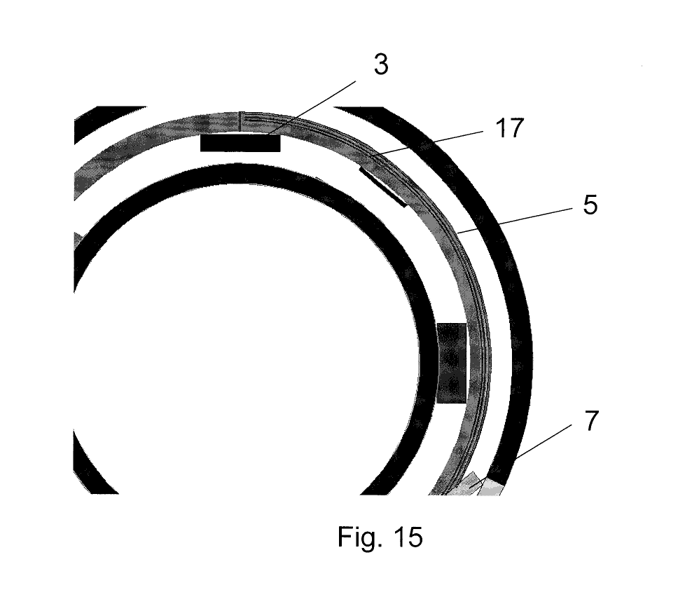

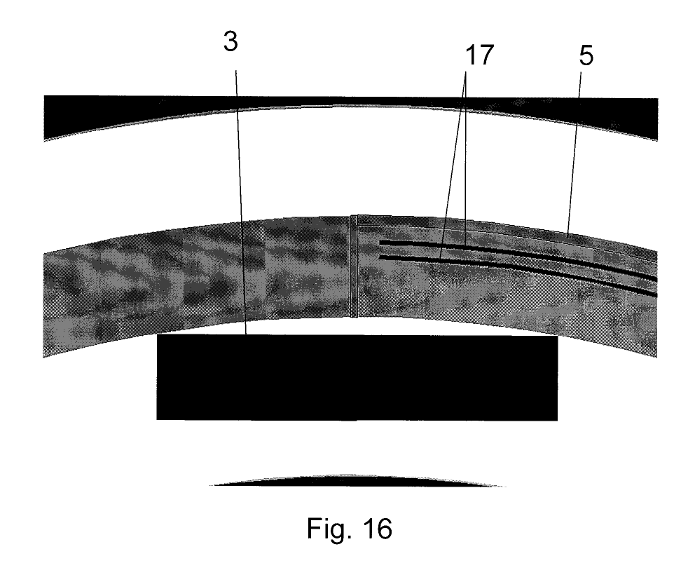

In FIGS. 15 and 16, to reduce RF radiation generated from the antenna circuitry the FPCB has one or several intermediate ground planes 17, which serves to (i). reflect any RF radiation directed inward (ii). function as a ground plane for the antenna circuitry reducing return losses of the RF radiation and (iii). function as a circuit ground plane for the electrical components and, optionally also as a (iv). thermal heat sink. The electrical components are placed on the inner circumference of the FPCB in such an order to minimize RF radiation generated from the aforementioned antenna. Due to the design limitations inherit in the antenna circuitry, constituted of the antenna, microstrip line, RF transceiver, the order and placement of the same in respect to the ground planes are critical in order to obtain a sufficient shielding minimizing the aforementioned RF radiation. Thus the ground planes located in the FPCB are designed to stretch at least in-between from where the internal antenna is located on the outer circumference side of the FPCB and the RF transceiver located in the inner circumference side of the FPCB.

To further reduce the RF radiation on the electrical components as well as the users finger, the conformal coating 14, coated on the inner circumference of the FPCB, can be made (mixed) with such material which functions as a RF shielding. This material can be made of cenospheres (constituted of a range of nanoparticle sized metal oxides) which reflects RF radiation.

An intermediate metal strip layer 5 is designed to function as a microstrip feed (transmission) line, electrically connecting the RF transceiver with the internal antenna, preferably optimized to obtain 50 Ω matching impedance.

The range for the width and length of the microstrip feed line must be such that each dimension of the microstrip feed line radiates only the required frequency (2.4 GHz). For a toroidal shaped antenna of this invention thus requires a microstrip feed line length, Iₜᵣₐₙₛₘᵢₛₛᵢₒₙ_{_{—}}ₗᵢₙₑ^{circumference}, along the circumference of the ring described as Iₜᵣₐₙₛₘᵢₛₛᵢₒₙ_{_{—}}ₗᵢₙₑ^{circumference} (max)=0.30λ and Iₜᵣₐₙₛₘᵢₛₛᵢₒₙ_{_{—}}ₗᵢₙₑ^{circumference} (min)=0.20λ, where λ is the wavelength to the corresponding radiation frequency (λ=125 mm @ 2.4 GHz). In analogy, the microstrip feed line width is required to be in the range of w(min)=0.008λ and w(max)=0.028λ.

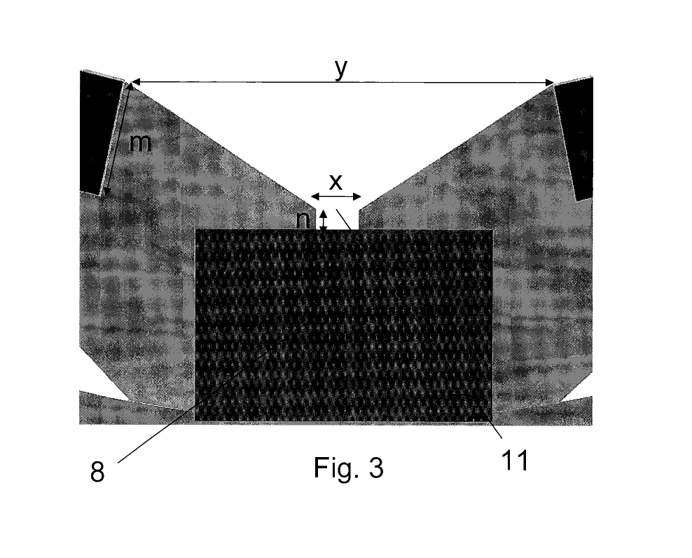

In FIG. 3, the aforementioned pressure sensor is located in a cavity within the electronic finger where the inlet hole geometry is shaped as a horn cone to maximize the pressure compression ratio at the pressure sensor end. To optimize sensitivity the inlet hole should have a minimum aspect ratio size difference of the diameter of the narrow end, x, of the horn cone to the outer end, y as 1:10; equivalently, the total height, m, of the horn cone should have an aspect ratio size to the height of the narrow end of the horn cone, n, as 6:1.

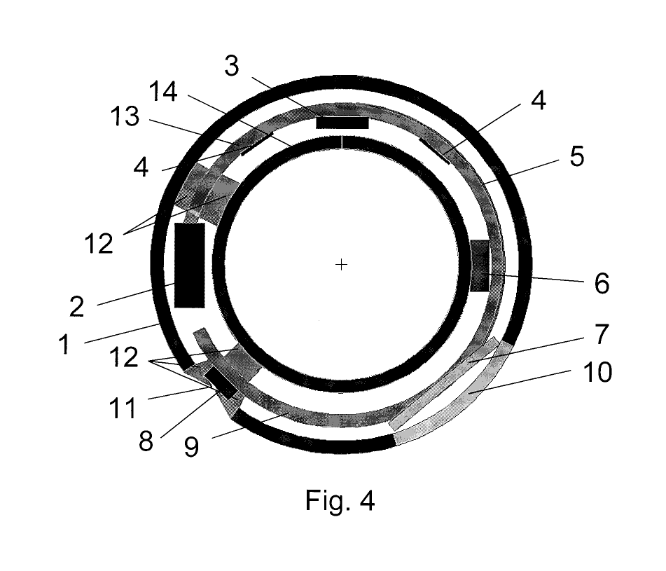

The pressure sensor can be located in two alternative positions as seen in FIG. 1 and FIG. 4 to steer in a 4^{th} dimension, the former by vertical finger movement (i.e. bending) of the finger the electronic finger ring is mounted on; the later by, for example, a finger on the other hand of the user. In FIG. 1, the pressure sensor 8 and the inlet hole are located so that the cavity housing the sensor 8 faces the inner circumference of the toroidal shaped finger ring structure 1. This location makes the pressure on the pressure sensor increase when the finger carrying the ring is bended since the tissue of the lower part of the finger then becomes compressed and expanded in its radial direction. Thus, steering an external device to which the ring is connected in a 4^{th} dimension is easily achieved by simply bending/vertically moving the finger carrying the ring. In FIG. 4, the pressure sensor 8 and the inlet hole are located so that the cavity housing the sensor 8 faces the outer circumference of the toroidal shaped finger ring structure 1. In this case, activation of the pressure sensor and hence steering of the external device in the 4^{th} dimension may be achieved by pressing the pressure sensor 8 with either another finger of the hand carrying the ring, or a finger of the other hand. Preferably, in this scenario, the pressure sensor 8 is activated by using the thumb of the hand on which the ring is carried.

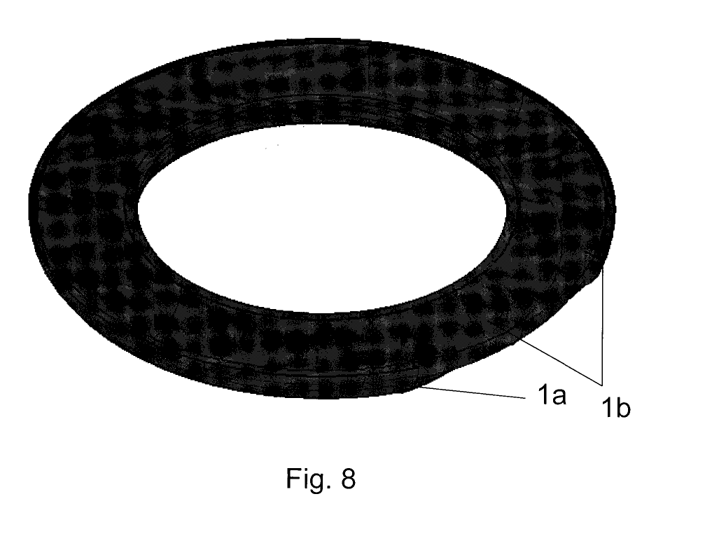

In FIG. 8 constituting the top metal layer on the interfaces of the toroidal halves (including the intermediate metal strip layer), is a material which has two functions, (i). to enhance the welding between the joints by its chemical, adhesive properties and (ii). enhancing the hermetic encapsulation (i.e. lowering the pressure in the sealed ring cavity) by its getter properties. This material could be made of titanium (Ti) compositions. Material compositions containing Ti are well known to have a low thermal conductivity as well as good getter properties (for most commonly existing gases that are out-gassing: oxygen, water vapour and hydrocarbons). The activation of the metallic getter film is done during the welding procedure by heat transfer where the metal surface reacts with gas atoms in the newly created cavity, locking them into the getter. These trapped atoms diffuses into the getter, thereby renewing the metal surface, ready to adsorb more gas atoms and hereby reducing the pressure obtaining an hermetic seal.

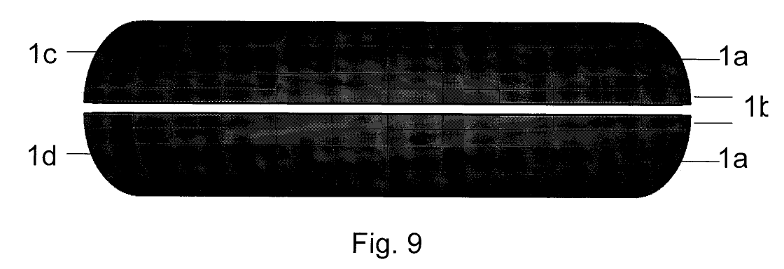

In FIG. 9 during fabrication of the electrical finger ring, welding the respective halves 1c, 1d of the toroidal ring, excessive heat is produced. Weld pool width is an important parameter dependent on the laser spot size. The weld absorption of the material, constituting the intermediate metal layer, is dependent on its energy transfer efficiency, During the welding procedure, melting the interfaces of the respective toroidal halves, to concurrently not damage the internal electrical components the laser pulse time must be <2.2 ms.

Concurrently, the aforementioned nonconductive, conformal coating acts as a thermal heat absorber to reduce the overall thermal stress on the electrical components during the welding procedure.

The aforementioned material used for the top metal layer on the interfaces of the toroidal halves and the nonconductive, conformal coating enables a greater freedom in design regarding the respective thicknesses and patterning chosen to optimize the hermetic encapsulation and thus increase the lifetime of the internal, electrical components.

In an embodiment of the present invention, the aforementioned cenospheres can further be deposited on the exterior of the inner circumference of the ring shell in order to reduce RF radiation on the user's finger (not shown).

In an embodiment of the present invention to adapt and optimize to different applications the antenna has different designs: (i). external omnidirectional (ii). internal integrated unidirectional (iii). internal integrated unidirectional with extended, elevated housing (iv). dielectric integrated with folded monopole.

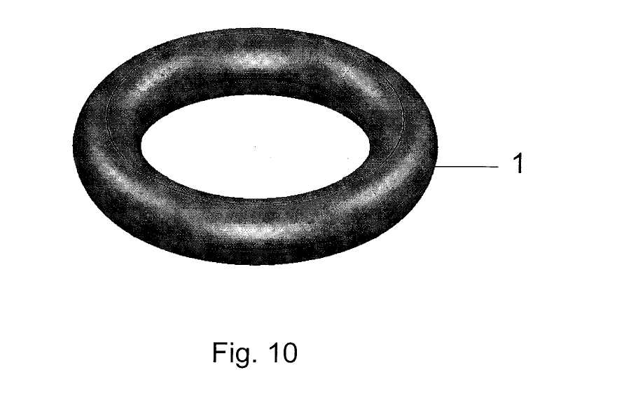

In FIG. 10 the external, coarse antenna is omnidirectional and constituted of a toroidal shaped metal ring, to obtain coarse tuning to the operational frequency. The external antenna's electrical length should be one wavelength, one half wavelength (a dipole) or one quarter wavelength with a ground plane to minimize all but real antenna impedances. It is reminiscent of a circular disc monopole (CDM) antenna but without the monopole acting as a ground plane. To obtain a coarse tuning to match 2.4-2.5 GHz (Bluetooth frequency range) the external antenna's diameter of the toroidal ring is calculated to 12-15 mm. As a coarse tuning is needed, either the outer- or inner diameters of the toroidal finger ring is sufficient to obtain matching impedance. The external antenna is connected to the internal antenna by the toroidal shaped ring by a metallic wall vertical to its circumference (not shown).

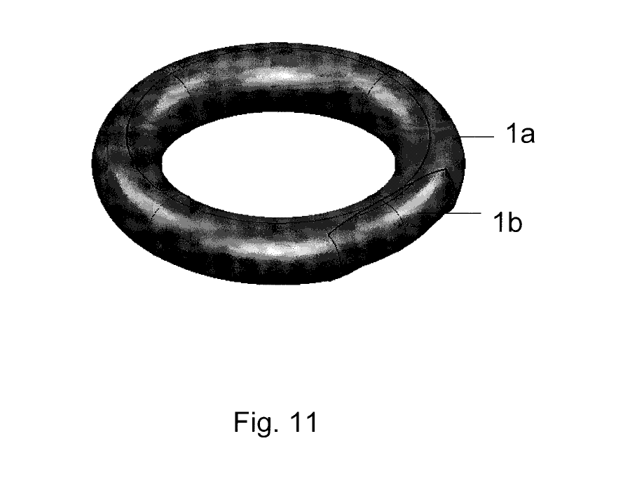

In FIG. 11 the second alternative is the internal integrated unidirectional antenna. The antenna could be an Inverted-F antenna (IFA), either (i). mounted on the flexible printed circuit board or (ii). integrated/printed in the flexible printed circuit board as part of its fabrication (not shown). Any other type of unidirectional antenna can also be used. The antenna is located under the portion of the ring which has no outer shell metal deposited on the toroidal shaped ring facing outwards, geometrically described as radially away from the toroids centre. The opening is a maximum of 12 mm along the circumference functioning as a window housing made of a titanium compound to allow unperturbed RF radiation. The electronic finger ring needs only to be provided with this type of opening, or RF window, when the outer shell is completely or almost completely made of a metal having substantial adverse effects on RF radiation, such as gold or silver. There is normally no need for an RF window when the outer shell or the complete ring is made of a non-RF shielding material, such as a plastic compound. The use of an RF window, however, allows the rest of the outer shell to be made of gold, silver or any other precious metal having adverse effects on RF radiation and thereby give the user the sensation of a conventional jewellery ring.

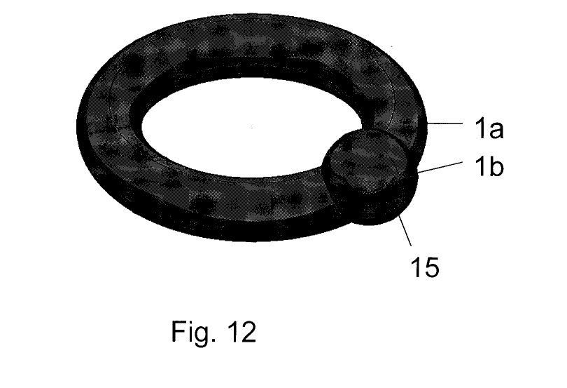

In FIG. 12 the third alternative is a toroid shaped finger ring with a locally extended, elevated sphere shape 15 to function as a housing for the internal integrated unidirectional antenna constituted of 1b, minimizing return losses of the RF radiation. The radius of the integrated sphere shape is a maximum of 7 mm. The extended housing will make it possible to place the internal antenna further away, elevated, from the ground plane of the flexible printed circuit board; as opposed to being mounted directly on the flexible printed circuit board. This significantly reduces the return losses of the RF radiation. Concurrently, the aforementioned nonconductive, conformal coating acts in this case also as a dielectric cavity in the interspace between the antenna and the ground plane.

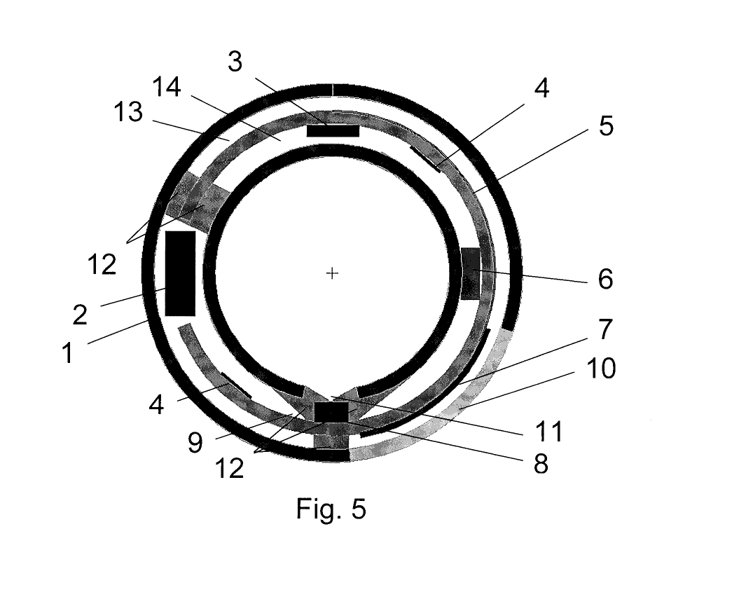

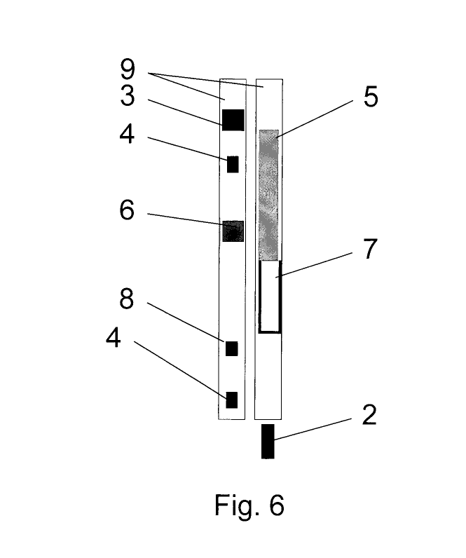

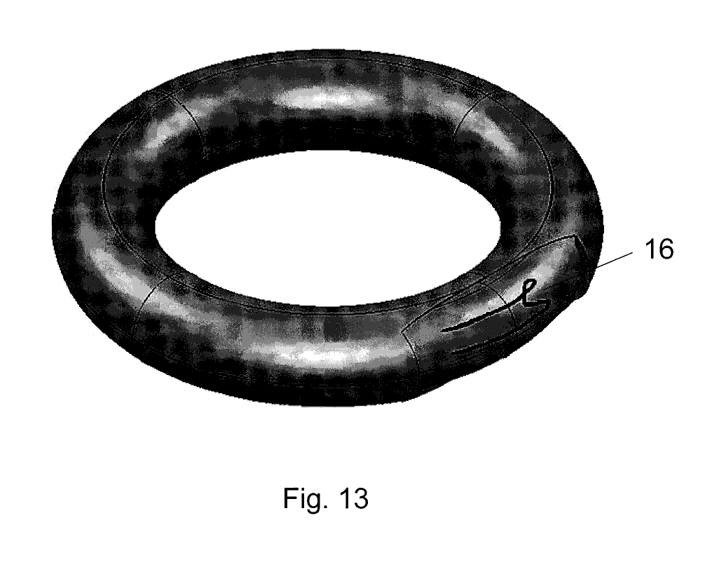

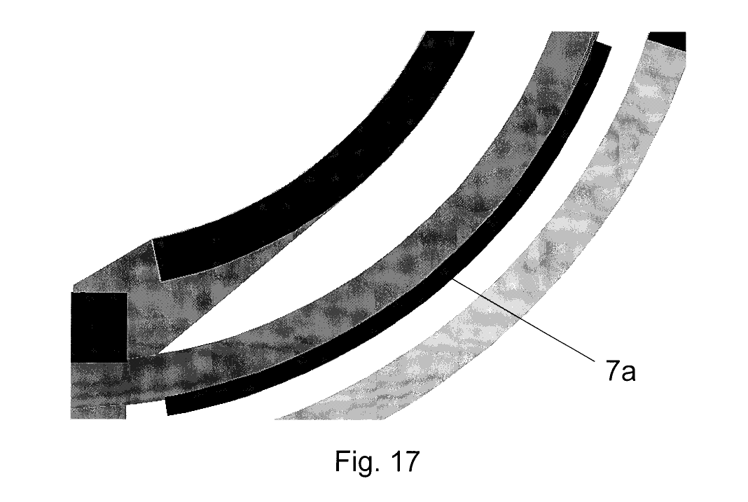

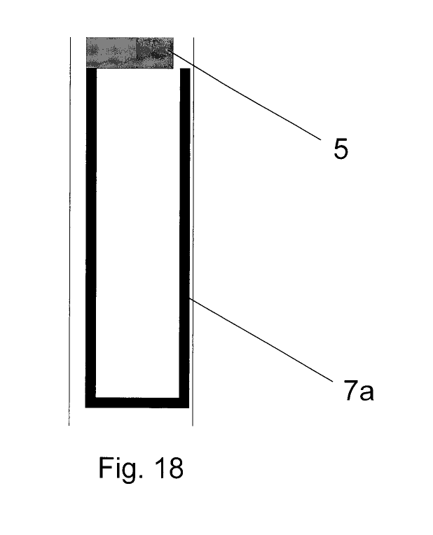

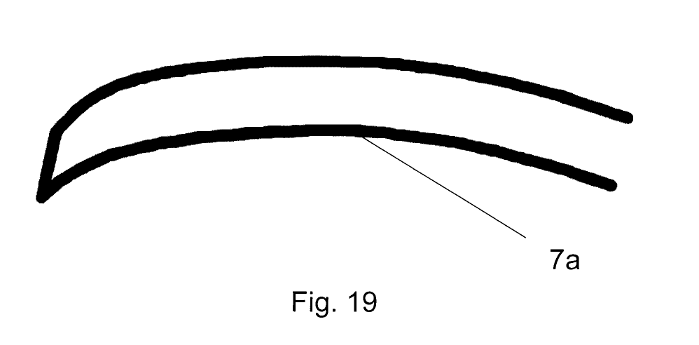

In FIGS. 13 and 19 the fourth alternative is a portion of the toroidal ring constituted of a dielectric 16 integrated with a folded monopole antenna 7a. The dielectric may for example be made of ceramic or epoxy material. The dielectric may also be the protective coating layer 13 described with reference to FIG. 1. The monopole antenna is made of a wire or a strip of conductive material which is placed in the outer boundary of the dielectric portion of the toroidal shaped ring. One end of the antenna is free inside the dielectric portion and the other is electrically connected to the RF transceiver via a feed line (not shown). Alternatively, the monopole antenna 7a is integrated on the top layer of the flexible printed circuit board (FIGS. 5 and 17), with one end of the antenna free inside the dielectric portion (FIGS. 6 and 18), the other electrically connected to the RF transceiver via a feed line. The length of the antenna is determined by a quarter wavelength of the self-resonating frequency of 2.4 GHz, which corresponds to a total length, L, of the folded wire as L=31 mm.

In an embodiment of the present invention, to complete the design of the aforementioned antenna designs are combined with a ground plane located in either (i). in intermediate layers in the FPCB (FIGS. 15 and 16) or (ii). when a portion of the toroidal shaped ring has a dielectric part integrated with folded monopole antenna, the remaining toroidal shaped outer metallic shell functions as a ground plane (FIG. 13).

The ground plane is designed to minimize RF losses by having a length along the circumference which results in low impedance. This implies a length I_{ground}_{_{—}}ₚₗₐₙₑ^{circumference}=λ/2n, where n=1,2,3 . . . .

The invention has mainly been described above with reference to a number of explicitly disclosed embodiments. However, as is readily appreciated by a person skilled in the art, other embodiments than the ones disclosed above are equally possible within the scope of the invention.

For example, in one embodiment of the invention the toroidal shaped finger ring structure, constituted of two torodial shaped shell halves, can alternatively encapsulate non-hermetically the electrical components by fixating their respective complementary interfaces with one or more screws in order to obtain a lower cost fabrication solution.

Another example, mounting fewer amount of components than described above (i.e. only microcontroller, bluetooth, microstrip and antenna) the components may be mounted on only one side of the fpcb along the circumference of the toroidal shaped fingering structure in order to obtain a lower cost fabrication solution. Note, in this embodiment, the electronic circuit may function passively (i.e. no battery needed) communicating with near field technology (RFID, proximity cards etc.) which transfers signal via magnetic field induction using the above described antenna design.

Another example, in one embodiment the torodial ring shell can be made of plastic instead of metal wherein the above mentioned conformal coating, coated either (or both) on the (i). inner circumference of the fpcb, or (ii). be deposited on the exterior of the inner circumference of the ring shell, mixed with cenospheres to function as a RF shielding on the users finger.

Concurrently, the plastic torodial ring shell could be made of light emitting polymers (LEP) electrically connected to the fpcb. In this embodiment the ring shell could communicate visually with its immediate vicinity by emitting electromagnetic radiation, for example a red colour, in order to communicate to other people that the user belongs to the “red” debate team just created at the college seminar course. In practice, the microcontroller may be configured to, in response to a signal received internally by the pressure- or accelerometer sensor of the ring, to send the correct current to the LEP ring shell to obtain the desired wavelength emitted. Alternatively, the microcontroller may be configured in response to a signal received from an external unit.

For example, in one embodiment, the electronic finger ring may be used as a means of communication in order to call for the attention of the ring carrier. In this embodiment, the ring may comprise a heat generating means configured to supply heat to the finger of the user in response to reception of a signal from an external unit by the RF antenna circuitry. To this end, the microcontroller may be configured to, in response to a signal received by the RF antenna circuitry, control the heat generating means to transfer heat to the inner circumference of the ring (i.e. the surface facing the finger of the user) so that the user is notified that the signal is received by the increased temperature of the ring. For example, the external unit may be a mobile phone, or a network node forwarding a signal from a mobile phone, and the signal may be any signal intended to call for the attention of the ring user. For example, the signal may be a signal indicating that the ring user has received a text message on his/her mobile phone, or a signal originating from a communication device of a friend who wants to signal to the ring user that he/she is thinking about the ring user. The heat generating means may for example be a resistive heating film in thermal contact with a metallic shell of the finger ring facing its inner circumference and contacting the finger of the user.

In one embodiment, the ring comprises a micromechanical component as part of the electronic circuit in the form of a vibration motor by means configured to supply mechanical vibrations to the finger of the user in response to reception of a signal from an external unit. To this end, the microcontroller may be configured to, in response to a signal received by an antenna of the ring, control the magnitude or time interval (frequency) generated so that the user is notified that the signal is received by the vibrations of the ring. For example, the external unit may be a mobile phone, or computer forwarding a signal addressed from an online game the ring user is connected to, which signal indicates that he or she has been hit or touched by a gaming participant at some instance during the game.

In one embodiment, the aforementioned pressure sensor is located in a cavity within the electronic finger having the inlet hole facing the inner circumference opening optimized, as above described geometry, to function as a finger plethysmograph providing a non-invasive measurement for changes in finger blood flow reflected by pulse wave amplitude (PWA). The end application used could either be, for example, for medical, health or dating purposes.

In one embodiment, the aforementioned pressure sensor, when located in the cavity within the electronic finger having the inlet hole facing the inner circumference opening, could be replaced by a temperature sensor sensing the temperature of the fingering user. The end application used could either be, for example, for medical, health or dating purposes.

The electronic finger ring has herein been described mainly in the context of an electronic finger ring functioning as a 4-dimensional steering device for controlling an external electronic device, such as a computer. However, it should be appreciated that many of the teachings disclosed herein are advantageous also when the electronic finger ring is adapted for other applications, such as identification, electronic payment, etc., mentioned in the summary of the invention, or for “heat- or vibration or light emitting communication” as described in the above passage.

It should also be understood that the set of electronic and/or electromechanical components integrated in the ring may be easily adapted to the intended use of the ring. For example, the electronic finger ring needs not to include an accelerometer or a pressure sensor when used for identification of the user wearing it. In this case, it may be sufficient to integrate the microcontroller (programmed with an identification number or the like) and the antenna circuitry in the electronic finger ring.

Consequently, it should be understood that the following aspects of the invention are also encompassed by this disclosure:

Aspect 1: An electronic finger ring comprising:
a toroidal shaped finger ring structure having an outer metal shell, and
a microcontroller and RF antenna circuitry integrated in said toroidal shaped finger ring structure for communicating with an external, electronic device,
wherein an internal antenna of the RF antenna circuitry is located under an opening in said outer metal shell serving as a window for RF radiation.
   Aspect 2: The electronic finger ring according to aspect 1, wherein the internal antenna is connected to the outer metal shell which is adapted to serve as an external antenna for coarse tuning to an operational frequency.

Aspect 3: The electronic finger ring according to aspect 1 or 2, further comprising an inner shell, and wherein the opening in the outer metal shell leaves the inner shell exposed, the inner shell preferably comprising a titanium compound.

Aspect 4: An electronic finger ring comprising:
a toroidal shaped finger ring structure having an outer metal shell, and
a microcontroller and RF antenna circuitry integrated in said toroidal shaped finger ring structure for communicating with an external, electronic device,
wherein an internal antenna of the RF antenna circuitry is connected to the outer metal shell which is adapted to serve as an external antenna for coarse tuning to an operational frequency.

Aspect 5: The electronic finger ring according to any of the preceding aspects, wherein the internal antenna is connected to an RF transceiver of the RF antenna circuitry through a metal strip layer serving as a microstrip feed line.

Aspect 6: The electronic finger ring according to any of the preceding aspects, wherein the ring further comprises at least one ground plane for reflecting RF radiation directed inwardly, the ground plane preferably stretching at least between the internal antenna and an RF transceiver of the RF antenna circuitry.

Aspect 7: The electronic finger ring according to any of the preceding aspects, further comprising an elevated sphere shape functioning as a housing for the internal integrated antenna.

Aspect 8: An electronic finger ring comprising:
a toroidal shaped finger ring structure having an outer shell, and
electronic components comprising at least a microcontroller and RF antenna circuitry integrated in said toroidal shaped finger ring structure for communicating with an external, electronic device,
wherein the outer shell comprises a top and bottom half that are welded together along an interface comprising a material having getter properties to enhance the hermetic encapsulation of the printed circuit board and the electric components.

Aspect 9: The electronic finger ring according to aspect 8, wherein the material also has chemical, adhesive properties.

Aspect 10: The electronic finger ring according to aspect 8 or 9, wherein the material is a metallic getter film the getter properties of which are activated by heat transfer during the welding procedure.

Aspect 11: The electronic finger ring according to any of the aspects 8 to 10, wherein the material comprises a titanium compound.

Aspect 12: Method for manufacturing an electronic finger ring comprising the steps of:
providing a top and bottom half of a shell of a toroidal shaped finger ring structure;
mounting inside and along the circumference of a first of said halves a flexible printed circuit board comprising electronic components;
integrating said flexible printed circuit board and the electronic components in a toroidal finger ring structure by welding the first and the second of said halves together along an interface between the two halves, and
before welding the two halves together, forming said interface at least partially of a material having getter properties to enhance the hermetic encapsulation of the printed circuit board and the electric components.

Aspect 13: Method according to aspect 12, wherein said interface is at least partially formed of a material having both getter properties and chemical, adhesive properties enhancing the welding between the two halves.

Aspect 14: Method according to aspect 12 or 13, wherein the interface material is a titanium composition.

Aspect 15: Method for manufacturing an electronic finger ring comprising the steps of: fixating the respective complementary top and bottom half of the toroidal shaped shell interfaces with one or more screws in order to obtain a non-hermetic encapsulation of the electrical components.

Aspect 16: An electronic finger ring comprising:
a toroidal shaped finger ring structure having an outer shell, and
electronic components comprising at least a microcontroller and RF antenna circuitry integrated in said toroidal shaped finger ring structure for communicating with an external, electronic device,
the electronic components being fabricated or mounted on a flexible printed circuit board which is packaged inside, along the circumference of the toroidal shaped finger ring structure, the RF antenna circuitry comprising an internal antenna being arranged either in the flexible printed circuit board or between the flexible printed circuit board and the outer boundary of the toroidal shaped finger ring structure, wherein the electronic finger ring further comprises RF shielding coating between the inner boundary of the toroidal shaped finger ring structure and the flexible printed circuit board to shield the user's finger from RF radiation.

Aspect 17: An electronic finger ring comprising:
a torodial ring shell that is made of plastic instead of metal wherein the conformal coating, is either coated (or both) on the (i). inner circumference of the fpcb, or (ii). on the exterior of the inner circumference of the ring shell, and mixed with cenospheres to function as a RF shielding on the users finger.

Aspect 18: The electronic finger ring according to aspect 17 wherein the plastic torodial ring shell is made of a light emitting polymer (LEP) electrically connected to the fpcb to optically communicate (emitting) with others in the users immediate vicinity.

Aspect 19: The electronic finger ring according to aspect 16, wherein at least one of the electronic components is arranged between the flexible printed circuit board and the inner boundary of the toroidal shaped finger ring, and wherein the RF shielding coating is provided on the inner side of the flexible printed circuit board so that the RF shielding coating shields both the user's finger and the at least one electronic component from RF radiation.

Aspect 20: An electronic finger ring comprising:
a toroidal shaped finger ring structure having a metal shell intended to contact a finger of a user wearing the ring, and
electronic components integrated in said toroidal shaped finger ring structure, comprising at least a microcontroller, an RF antenna circuitry for communicating with an external, electronic device, and a heat generating means,
wherein the heat generating means is adapted to supply heat to the metal shell of the toroidal shaped finger ring structure in response to a signal received by the RF antenna circuitry from the external device.

Aspect 21: Electronic finger ring according to aspect 20, wherein the microcontroller is adapted to analyse the received signal and control the heat generating means to supply heat to the metal shell if the signal indicates that the user's attention should be called for.

Aspect 22: Electronic finger ring according to aspect 20 or 21, wherein the heat generating means is a resistive heating film arranged in thermal contact with the metal shell of the toroidal shaped finger ring structure.

Aspect 23: An electronic finger ring comprising:
a toroidal shaped finger ring structure having a metal shell intended to contact a finger of a user wearing the ring, and
electronic components integrated in said toroidal shaped finger ring structure, comprising at least a microcontroller, an RF antenna circuitry for communicating with an external, electronic device, and a vibrating generating means,
wherein the vibrating generating means is adapted to supply vibrations to the whole finger ring and its user in response to a signal received by the RF antenna circuitry from the external device.

Aspect 24: Electronic finger ring according to aspect 23, wherein the microcontroller is adapted to analyse the received signal and control the vibrating generating means to supply vibrations to the whole finger ring and its user if the signal indicates that the user's attention should be called for.

Aspect 25: Electronic finger ring according to aspect 23 or 24, wherein the vibrating generating means is a micromechanical vibrational motor that is connected to the electronic circuit within the toroidal shaped finger ring structure.

Aspect 26: An electronic finger ring comprising:
a toroidal shaped finger ring structure having a metal shell intended to contact a finger of a user wearing the ring, and
electronic components integrated in said toroidal shaped finger ring structure, comprising at least a microcontroller, an RF antenna circuitry for communicating with an external, electronic device, and a pressure sensing means located in a cavity within the electronic finger having the inlet hole facing the inner circumference opening optimized, as above described geometry, to function as a finger plethysmograph providing a non-invasive measurement
wherein the pressure sensing means is adapted to detect pressure differences from changes in finger blood flow of the user.

Aspect 27: The electronic finger ring according to any of the preceding aspects, wherein all electrical components of the electronic finger ring are fabricated or mounted on a flexible printed circuit board which is packaged inside, along the circumference of the toroidal shaped finger ring structure.

Aspect 28: The electronic finger ring according to any of the preceding aspects, wherein the electronic components of the electronic finger ring includes one or more of:
a power source, such as a battery, an inductive coil, and/or piezoelectric nanofibers, for powering active electronic components of the finger ring;
an accelerometer for steering the external device in a 3-dimensional space based on motions of the user's hand, and
a pressure sensor for steering the external device in a 4^{th} dimension.

1. An electronic finger ring for steering an external electronic device in up to four dimensions, comprising:
a toroidal shaped finger ring structure having an outer shell, and
electronic components comprising a micro processor, RF antenna circuitry, an accelerometer, and a pressure sensor, all fabricated or mounted on a flexible printed circuit board, FPCB, which is packaged inside, along the circumference of the toroidal shaped finger ring structure.

2. The electronic finger ring according to claim 1, wherein the accelerometer is configured to steer in 3-dimensional space and the pressure sensor is configured to steer in an additional 4^{th} dimension.

3. The electronic finger ring according to claim 1, wherein the pressure sensor is located in a cavity within the electronic finger ring having an inlet hole.

4. The electronic finger ring according to claim 3, wherein the inlet hole is shaped as a horn cone to maximize the pressure compression ratio at the pressure sensor end.

5. The electronic finger ring according to claim 4, wherein to optimize sensitivity of the pressure sensor the inlet hole has a minimum aspect ratio size difference of the diameter of the narrow end (x) of the horn cone to the outer end (y) of the horn cone as 1:10.

6. The electronic finger ring according to claim 4, wherein the total height of the horn cone (m) should have an aspect ratio size to the height of the narrow end of the horn cone (n) as 6:1.

7. The electronic finger ring according to claim 3, wherein the pressure sensor and the inlet hole are located so that the cavity faces the inner circumference of the toroidal shaped finger ring structure to allow pressure to be applied to the pressure sensor by bending the finger carrying the ring.

8. The electronic finger ring according to claim 3, wherein the pressure sensor and the inlet hole are located so that the cavity faces the outer circumference of the toroidal shaped finger ring structure to allow pressure to be applied to the pressure sensor by using another finger not carrying the ring.

9. The electronic finger ring according to claim 1, wherein the outer shell is made of metal, and wherein the RF antenna circuitry comprises an internal antenna located under an opening in the outer metal shell serving as a window for RF radiation.

10. The electronic finger ring according to claim 9, wherein the toroidal shaped finger ring structure comprises a locally extended, elevated sphere shape functioning as a housing for the internal antenna and minimizing return losses of the RF radiation.

11. The electronic finger ring according to claim 9, further comprising an inner shell, and wherein the opening in the outer metal shell leaves the inner shell exposed, the inner shell comprising a titanium compound.

12. The electronic finger ring according to claim 9, wherein the internal antenna is connected to the outer metal shell which is adapted to serve as an external, omnidirectional antenna obtaining coarse tuning to an operational frequency.

13. The electronic finger ring according to claim 1, wherein the outer shell of the toroidal shaped finger ring structure is constituted of two toroidal complementing halves which are welded together along an interface between the two halves.

14. The electronic finger ring according to claim 13, wherein the interface comprises a material having getter properties to enhance the hermetic encapsulation of the printed circuit board and the electric components.

15. The electronic finger ring according to claim 14, wherein the material also has chemical, adhesive properties enhancing the welding between the two halves.

16. The electronic finger ring according to claim 1, wherein the electronic components further comprises a battery.

17. The electronic finger ring according to claim 1, further comprising a protective coating having RF shielding properties located between the inner boundary of the toroidal shaped finger ring structure and the flexible printed circuit board.

18. The electronic finger ring according to claim 17, wherein the protective coating comprises cenospheres.

19. The electronic finger ring according to claim 1, wherein the RF antenna circuitry comprises a microstrip feed line, which has a shape designed to stretch along the circumference of the toroidal shaped finger ring structure and which is electrically optimized to obtain 50 Ω matching impedance.

20. The electronic finger ring according to claim 19, wherein the width and length of the microstrip feed line are selected such that each dimension of the microstrip feed line radiates at 2.4 GHz.

21. The electronic finger ring according to claim 1, further comprising at least one ground plane designed to minimize RF losses and having a length along the circumference of the toroidal finger ring structure of I_{ground}_{_{—}}ₚₗₐₙₑ^{circumference}=λ/2n, where n=1,2,3 . . . .

22. The electronic finger ring according to claim 21, wherein the at least one ground plane stretches at least in-between an internal antenna of the RF antenna circuitry, located on the outer circumference side of the flexible printed circuit board and an RF transceiver of the RF antenna circuitry, located on the inner circumference side of the flexible printed circuit board.
